(19) United States
(12) Patent Application Publication
(10) Pub. No.: US 2026/0172344 A1
(43) Pub. Date: Jun. 18, 2026

(54) ROUTER AND NETWORK PACKET TRANSMISSION METHOD

(71) Applicant: ASUSTEK COMPUTER INC, TAIPEI (TW)

(72) Inventor: Ching-Chuan CHIU, TAIPEI (TW)

(21) Appl. No.: 19/206,550

(22) Filed: May 13, 2025

(30) Foreign Application Priority Data
Dec. 17, 2024 (TW) 113149112

(51) Int. Cl. H04L 45/302

(52) U.S. Cl. CPC H04L 45/302

(57) ABSTRACT

A router is provided, applied to be connected to a terminal apparatus. The router includes a network interface module, a packet type determining module, and a priority control module. The network interface module is configured to receive a network packet from the terminal apparatus. The packet type determining module is configured to determine a priority of the network packet according to a data category of the network packet. The priority control module is configured to perform transmission control on the network packet according to the determined priority. A network packet transmission method is also provided, applicable to the router.

### CROSS-REFERENCE TO RELATED APPLICATION

This application claims the priority benefit of Taiwan Application Serial No. 113149112, filed on Dec. 17, 2024. The entirety of the above-mentioned patent application is hereby incorporated by reference herein and made a part of specification.

### BACKGROUND OF THE INVENTION

### Field of the Invention

The disclosure relates to the field of network communication technologies, and in particular, to a router and a network packet transmission method.

### Description of the Related Art

Quality of service (QoS) management in a wireless network is vital to improving network user experience. Different priorities are set for different users or different data flows, to ensure that efficiency of overall network data transmission reaches a particular level.

Conventionally, a priority of the quality of service management is defined by a client. However, this processing manner easily causes a priority disorder due to an incorrect definition by the client, affecting the efficiency of overall network data transmission.

### BRIEF SUMMARY OF THE INVENTION

The disclosure provides a router, applied to be connected to a terminal apparatus. The router includes a network interface module, a packet type determining module, and a priority control module. The network interface module is configured to receive a network packet from the terminal apparatus. The packet type determining module is configured to determine a priority of the network packet according to a data category of the network packet. The priority control module is configured to perform transmission control on the network packet according to the determined priority.

The disclosure also provides a network packet transmission method, applicable to a router. The router is applied to be connected to a terminal apparatus. The network packet transmission method includes the following steps: receiving, by using the router, a network packet from the terminal apparatus; determining, by using the router, a priority of the network packet according to a data category of the network packet; and performing, by using the router, transmission control on the network packet according to the determined priority.

According to the router and the network packet transmission method provided in the disclosure, a priority of a network packet is determined according to a data category of the network packet, to perform transmission control. In this way, the problem that a priority disorder due to an incorrect definition by a client is resolved, thereby ensuring efficiency of overall network data transmission.

### BRIEF DESCRIPTION OF THE DRAWINGS

FIG. 1 is a schematic diagram of a router according to an embodiment of the disclosure;

FIG. 2 is a flowchart of a network packet transmission method according to an embodiment of the disclosure;

FIG. 3 is a schematic diagram of a router according to another embodiment of the disclosure; and

FIG. 4 is a flowchart of a network packet transmission method according to another embodiment of the disclosure.

### DETAILED DESCRIPTION OF THE EMBODIMENTS

More detailed descriptions of specific embodiments of the disclosure are provided below with reference to the schematic diagrams. The advantages and features of the disclosure will be better understand according to the following description and appended claims. It needs to be noted that accompanying drawings are all in a simplified form and in an inaccurate scale. They are only used for assisting in describing the propose of the embodiments of the disclosure in a convenient and clear way.

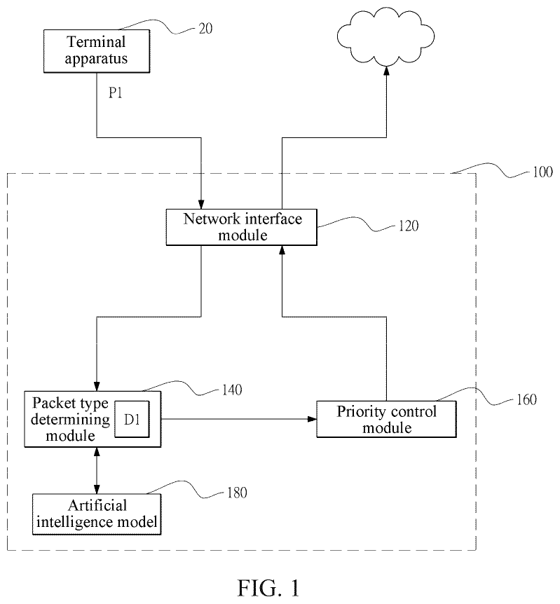

FIG. 1 is a schematic diagram of a router 100 according to an embodiment of the disclosure.

The router 100 is a network device, and is applied to be connected to a terminal apparatus 20 (in an embodiment, a computer), to connect the terminal apparatus 20 to another network.

As shown in the figure, the router 100 includes a network interface module 120, a packet type determining module 140, a priority control module 160, and an artificial intelligence model 180.

The network interface module 120 is configured to receive a network packet P1 from the terminal apparatus 20, and transmit the network packet P1 to the outside according to a determined priority, in an embodiment, to another network.

The packet type determining module 140 is configured to determine the priority of the network packet P1 according to a data category of the network packet P1. In an embodiment, the packet type determining module 140 determines the data category of the network packet P1 by using the artificial intelligence model 180, to determine the priority of the network packet P1. In an embodiment, the router 100 includes a processing unit with an edge computing capability. The processing unit directly classifies the network packet P1 in the router 100 by using an artificial intelligence function. In another embodiment, the artificial intelligence model 180 is integrated in the processing unit.

In an embodiment, the artificial intelligence model 180 is a classification model trained and suitable for classifying the network packet P1 to generate the priority, and classifies the network packet P1 according to the data category of the network packet P1.

In an embodiment, the artificial intelligence model 180 classifies, according to the data category of the network packet P1, the network packet P1 into four categories: a voice, a video, a best effort, and a background. The voice category, the video category, and other delay-sensitive network packets are endowed with a high priority, the best effort category is endowed with a normal priority, and the background category is endowed with a low priority. In an embodiment, the best effort category is a network packet generated by an application such as web page browsing or file downloading. In an embodiment, the background category is a network packet generated by an application such as background downloading or file transmission.

The packet type determining module 140 determines, by using the artificial intelligence model 180, the priority of the network packet P1 according to classification data generated by classifying the data category of the network packet P1. In an embodiment, the packet type determining module 140 sets transmission policy data D1. The transmission policy data D1 includes a plurality of data categories and a plurality of pieces of priority setting data corresponding to the plurality of data categories. After determining the data category of the network packet P1, the packet type determining module 140 determines the priority of the network packet P1 in cooperation with the transmission policy data D1.

After the packet type determining module 140 determines the priority of the network packet P1, the priority control module 160 performs transmission control on the network packet P1 according to the priority determined by the packet type determining module 140. In an embodiment, the priority control module 160 moves a network packet P1 with a high priority to a dedicated queue, to transmit data at a faster speed. The network packet P1 with the high priority first obtains a guaranteed transmission bandwidth. When there is a remaining bandwidth, the remaining bandwidth is sequentially allocated to a network packet P1 with a normal priority and a network packet P1 with a low priority.

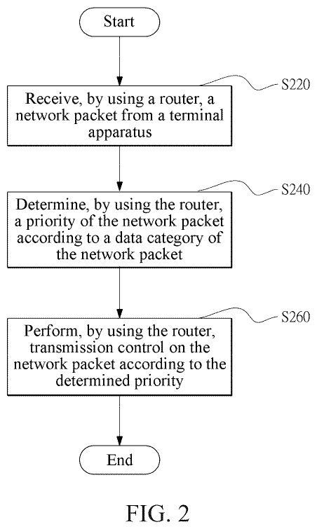

FIG. 2 is a flowchart of a network packet transmission method according to an embodiment of the disclosure. The network packet transmission method is applicable to the router 100 shown in FIG. 1, and includes the following steps.
Step S220: Receive, by using the router 100, a network packet P1 from a terminal apparatus 20. The step is performed by the network interface module 120 in FIG. 1.
Step S240: Determine, by using the router 100, a priority of the network packet P1 according to a data category of the network packet P1. The step is performed by the packet type determining module 140 in FIG. 1 in cooperation with the artificial intelligence model 180. The artificial intelligence model 180 is a classification model trained and suitable for classifying the network packet P1 to generate the priority, and classifies the network packet P1 according to the data category of the network packet P1.

In an embodiment, the artificial intelligence model 180 classifies, according to the data category of the network packet P1, the network packet P1 into four categories: a voice, a video, a best effort, and a background. The voice category, the video category, and other delay-sensitive network packets are endowed with a high priority, the best effort category is endowed with a normal priority, and the background category is endowed with a low priority.
Step S260: Perform, by using the router 100, transmission control on the network packet P1 according to the determined priority. The step is performed by the priority control module 160 in FIG. 1. In an embodiment, the priority control module 160 first ensures a transmission bandwidth for a network packet P1 with a high priority. When there is a remaining bandwidth, the remaining bandwidth is allocated to a network packet P1 with a normal priority and a network packet P1 with a low priority.

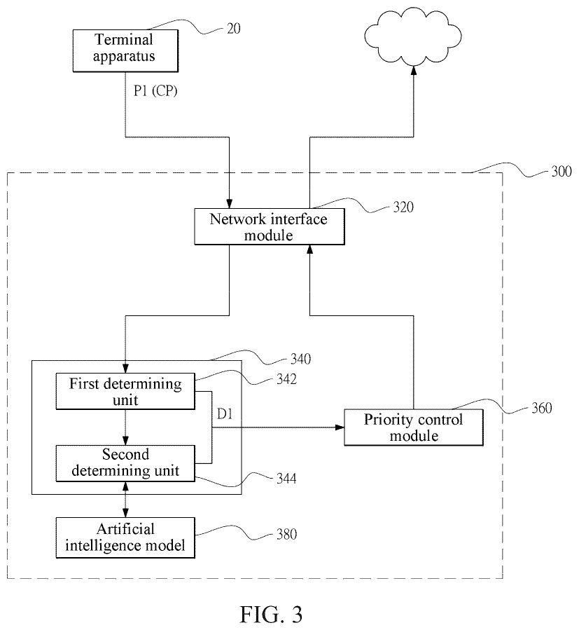

FIG. 3 is a schematic diagram of a router 300 according to another embodiment of the disclosure.

Similar to the router 100 in FIG. 1, the router 300 also includes a network interface module 320, a packet type determining module 340, a priority control module 360, and an artificial intelligence model 380. However, the router 300 in this embodiment is different from the router 100 in FIG. 1 in the packet type determining module 140.

Compared with the packet type determining module 140 of the router 100 in FIG. 1, the packet type determining module 340 in this embodiment includes a first determining unit 342 and a second determining unit 344, to determine a type of a network packet P1 in stages.

The first determining unit 342 and the second determining unit 344 use different determining principles. The first determining unit 342 is configured to read a feature code CP of the network packet P1 to determine a priority of the network packet P1. The second determining unit 344 is configured to classify the network packet P1 according to a data category of the network packet P1 by using the artificial intelligence model 380 to determine the priority of the network packet P1. The artificial intelligence model 380 is a classification model trained and suitable for classifying the network packet P1 to generate the priority.

In an embodiment, after the network interface module 320 receives and sends the network packet P1 to the packet type determining module 340, the first determining unit 342 first performs determining. The first determining unit 342 reads the feature code CP to determine the priority of the network packet P1. When the first determining unit 342 does not determine the priority, in an embodiment, the network packet P1 does not include the feature code CP, the second determining unit 344 classifies the network packet P1 by using the artificial intelligence model 380 to determine the priority.

Generally, when the terminal apparatus 20 generates the network packet P1, the feature code CP is set in the network packet P1, to indicate the priority of the network packet P1. In an embodiment, the terminal apparatus 20 sets, according to a type of a software program generating the network packet P1, a feature code CP in the network packet P1 to set the priority of the network packet P1.

After the packet type determining module 340 determines the priority of the network packet P1, the priority control module 360 performs transmission control on the network packet P1 according to the priority determined by the packet type determining module 340.

In the foregoing embodiment, the first determining unit 342 first determines the priority of the network packet P1 according to the feature code CP. In addition, the second determining unit 344 determines the priority when the first determining unit 342 does not determine the priority. In other words, the packet type determining module 340 does not need to classify all network packets P1 by using the artificial intelligence model 380 according to the data category of the network packet P1, but only needs to classify a network packet P1 without a feature code CP, thereby effectively reducing a calculation amount. In another embodiment, in addition to determining, by using the first determining unit 342, the priority of the network packet P1 according to the feature code CP, the packet type determining module 340 also performs, by using the second determining unit 344, classification according to the data category of the network packet P1 to determine the priority of the network packet P1, and determines a final priority according to determining results of the first determining unit 342 and the second determining unit 344.

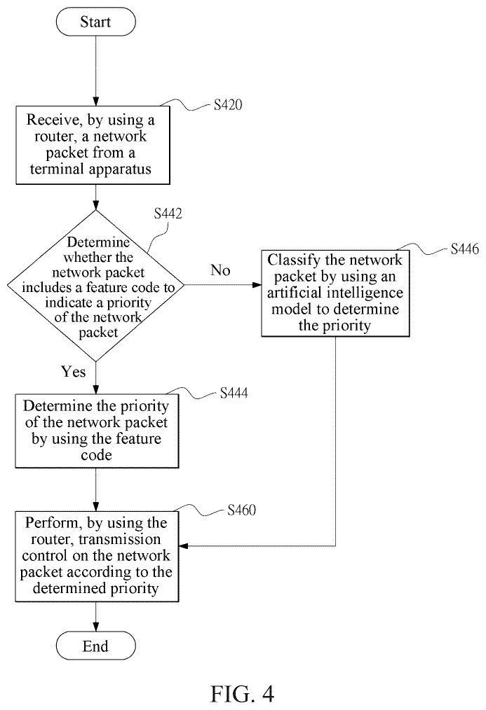

FIG. 4 is a flowchart of a network packet transmission method according to another embodiment of the disclosure. The network packet transmission method is applicable to the router 300 shown in FIG. 3, and includes the following steps.
Step S420: Receive, by using the router 300, a network packet P1 from a terminal apparatus 20. The step is performed by the network interface module 320 in FIG. 3.
Step S442: Determine whether the network packet P1 includes a feature code CP to indicate a priority of the network packet P1. When the network packet P1 includes the feature code CP, step S444 is performed: Read the feature code CP to determine the priority of the network packet P1. Step S442 and step S444 are performed by the first determining unit 342 in FIG. 3.

When the network packet P1 does not include the feature code CP, step S446 is performed: Classify the network packet P1 by using an artificial intelligence model 380 to determine the priority. The step is performed by the second determining unit 344 in FIG. 3.
Step S460: Perform, by using the router 300, transmission control on the network packet P1 according to the determined priority. The step is performed by the priority control module 360 in FIG. 3.

In this embodiment, the first determining unit 342 first determines the priority of the network packet P1 according to the feature code CP. In addition, the second determining unit 344 determines the priority when the first determining unit 342 does not determine the priority, and does not need to classify all network packets P1 by using the artificial intelligence model 380, thereby effectively reducing a calculation amount. In another embodiment, the first determining unit 342 and the second determining unit 344 are also used together to generate two pieces of priority data. Then, the priority of the network packet P1 is determined according to a default principle. In the default principle, a determining result of the second determining unit 344 is preferentially considered. In still another embodiment, the network packet P1 of the first determining unit 342 and the feature code CP are also used as training data to train a classification model used by the second determining unit 344.

In conclusion, according to the routers 100 and 300 and the method for transmitting a network packet P1 provided in the disclosure, a priority of the network packet P1 is determined according to a data category of the network packet P1, to perform transmission control. In this way, the problem that a priority disorder due to an incorrect definition by a client is resolved, thereby ensuring efficiency of overall network data transmission.

The foregoing is only exemplary embodiments of the disclosure, and does not constitute any limitation on the disclosure. Any form of equivalent replacements or modifications to the technical means and technical content disclosed in the disclosure made by a person skilled in the art without departing from the scope of the technical means of the disclosure still fall within the content of the technical means of the disclosure and the protection scope of the disclosure.

What is claimed is:

1. A router, applied to be connected to a terminal apparatus, the router comprising:
a network interface module, configured to receive a network packet from the terminal apparatus;
a packet type determining module, configured to determine a priority of the network packet according to a data category of the network packet; and
a priority control module, configured to perform transmission control on the network packet according to the determined priority.

2. The router according to claim 1, wherein the packet type determining module comprises a first determining unit and a second determining unit, the first determining unit is configured to read a feature code to determine the priority of the network packet, and the second determining unit is configured to classify the network packet by using an artificial intelligence model to determine the priority.

3. The router according to claim 2, wherein after the network interface module receives the network packet, the first determining unit reads the feature code to determine the priority of the network packet; and when the first determining unit does not determine the priority, the second determining unit classifies the network packet by using the artificial intelligence model to determine the priority.

4. The router according to claim 2, wherein the terminal apparatus is configured to set the feature code in the network packet.

5. The router according to claim 1, further comprising an artificial intelligence model, wherein the packet type determining module is configured to classify the network packet by using the artificial intelligence model to generate the priority.

6. The router according to claim 1, wherein the packet type determining module comprises transmission policy data, and the transmission policy data comprises a plurality of data categories and a plurality of pieces of priority setting data corresponding to the plurality of data categories.

7. The router according to claim 1, wherein the terminal apparatus is configured to set, according to a type of a software program generating the network packet, a feature code for the network packet to indicate the priority of the network packet.

8. A network packet transmission method, applicable to a router, wherein the router is applied to be connected to a terminal apparatus, and the network packet transmission method comprises:
receiving, by using the router, a network packet from the terminal apparatus;
determining, by using the router, a priority of the network packet according to a data category of the network packet; and
performing, by using the router, transmission control on the network packet according to the determined priority.

9. The network packet transmission method according to claim 8, wherein the step of determining, by using the router, a priority of the network packet according to a data category of the network packet comprises:
reading a feature code to determine the priority of the network packet; and
classifying, when the priority of the network packet is unable to be determined by using the feature code, the network packet by using an artificial intelligence model to determine the priority.

10. The network packet transmission method according to claim 9, wherein the terminal apparatus is configured to set the feature code in the network packet.

11. The network packet transmission method according to claim 8, wherein the terminal apparatus is configured to set, according to a type of a software program generating the network packet, a feature code for the network packet to indicate the priority of the network packet.
